(19) United States
(12) Patent Application Publication
(10) Pub. No.: US 2016/0077673 A1
(43) Pub. Date: Mar. 17, 2016

(54) Intelligent Canvas

(71) Applicant: MICROSOFT CORPORATION, Redmond, WA (US)

(72) Inventors: Sree Hari Nagaralu, Hyderabad (IN); Vijayendra Gopalrao Vasu, Hyderabad (IN); Karthikeyan Raman, Hyderabad (IN); Pavan Kumar Dasari, Hyderabad (IN); Ranganath Kondapally, Hyderabad (IN); Venkata Sai Ravali Busetty, Hyderabad (IN); Naveen Kumar Sethia, Hyderabad (IN)

(73) Assignee: MICROSOFT CORPORATION, Redmond, WA (US)

(21) Appl. No.: 14/486,156

(22) Filed: Sep. 15, 2014

(51) Int. Cl. G06F 3/0481; H04L 29/08

(52) U.S. Cl. CPC G06F 3/0481; H04L 67/06; H04L 67/10

(57) ABSTRACT

According to aspects of the disclosed subject matter, systems and methods for providing improved access to content accessible outside of the current execution context. On a computing device, an intelligent canvas is provided as an operating system-level service. By implementing and/or providing the intelligent canvas as an operating system-level service, interaction by a user with the intelligent canvas does not require a change from the current execution context. Upon receiving a request to interact with the intelligent canvas, an intelligent canvas view is presented for display. The intelligent canvas view includes a plurality of user-actionable controls and at least one user-actionable control corresponds to content for importing into the current execution context. Moreover, the corresponding content of the at least one user-actionable control is anticipatorily selected for presentation in the intelligent canvas view.

### BACKGROUND

Most computer users typically have several apps and/or applications running on a device. These apps and applications are designed to provide a predetermined set of services and functionality. Often, the services of one application will include information or data that serves as input to another application. Since app and application designers cannot reasonably foresee how information of a first application may be used as input to another application, it is left to the computer user to facilitate the transfer of information using whatever tools are available on the user's computer. Moreover, the available tools for transferring external data into an application's execution content provide only the most rudimentary services such that the user is often left with manually switching the execution context of an application to access and transfer the data back to the execution context.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods for providing improved access to content accessible outside of the current execution context are provided. On a computing device, an intelligent canvas is provided as an operating system-level service. By implementing and/or providing the intelligent canvas as an operating system-level service, interaction by a user with the intelligent canvas does not require a change from the current execution context. Upon receiving a request to interact with the intelligent canvas, an intelligent canvas view is presented for display. The intelligent canvas view includes a plurality of user-actionable controls and at least one user-actionable control corresponds to content for importing into the current execution context. Moreover, the corresponding content of the at least one user-actionable control is anticipatorily selected for presentation in the intelligent canvas view.

According to additional aspects of the disclosed subject matter, additional systems and methods for providing improved access to content accessible outside of the current execution context are presented. In one embodiment, computer-readable media bearing computer-executable instructions which, when executed on a computing device, carry out a method for providing improved access to content accessible outside of the current execution context. In execution, an intelligent canvas is provided as an operating system-level service. By implementing and/or providing the intelligent canvas as an operating system-level service, interaction by a user with the intelligent canvas does not require a change from the current execution context. In addition to the intelligent canvas, a content capture process is also provided on the computing device. In operation, the content capture process executes in the background of the computing device. Moreover, the content capture process is configured to capture content accessed by the user and store the captured content as one or more content cards in a content card index associated with the user. Upon receiving a request to interact with the intelligent canvas, an intelligent canvas view is presented for display. The intelligent canvas view includes a plurality of user-actionable controls and at least one user-actionable control corresponds to content for importing into the current execution context. Moreover, the corresponding content of the at least one user-actionable control is anticipatorily selected for presentation in the intelligent canvas view from the captured content in the content card index.

According to still further aspects of the disclosed subject matter, a computer device for providing improved access to content accessible outside of the current execution context is presented. The computing device comprises a processor and a memory, wherein the processor executes instructions stored in the memory as part of or in conjunction with additional components in providing improved access to content. The additional components include at least a content capture component and an intelligent clipboard. The content capture component is configured to operate in the background on the computing device. The content capture component is further configured to capture content accessed by a user of the computing device and store the captured content in a content card index.

Further still, according to various embodiments of the disclosed subject matter, an intelligent clipboard is provided. The intelligent clipboard is configured to operate as an operating system-level service on the computing device. Generally speaking user interfaces/interacts with the intelligent clipboard as he/she would with a “typical” clipboard, e.g., via cut, copy, and paste operations, which user interactions are well known. However, unlike a typical clipboard, the intelligent clipboard captures rich information regarding the data that is being captured to the clipboard (i.e., stored in a temporary data store/memory for use by the clipboard). This rich information includes semantic data, relationships, structural organization, etc. Further, upon capturing data to the intelligent clipboard (typically via a copy or cut operation) one or more content cards are generated for the captured data/content. Unlike the intelligent canvas, these dynamically generated content cards are not stored in a content index, but simply maintained by the intelligent clipboard so long as the data remains as the subject matter of the intelligent clipboard. Advantageously, when pasting content from the intelligent clipboard, the rich information of the dynamically generated content card (or content cards) regarding the captured content may be used.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is block diagram illustrating the interaction between exemplary components of a computing device suitably configured to implement various aspects of the disclosed subject matter;

FIG. 2 is a flow diagram illustrating an exemplary routine for capturing user-relevant content via a content capture process, and generating content cards and storing and indexing them in a content card index corresponding to a computer user;

FIGS. 3A-3D are pictorial diagrams illustrating user interaction with an illustrative embodiment of an intelligent canvas implemented on a computing device;

FIGS. 4A-4D are pictorial diagrams illustrating an alternative user interaction with an illustrative embodiment of an intelligent canvas implemented on an alternative computing device;

FIG. 5 is a flow diagram illustrating an exemplary routine for implementing an intelligent canvas on a computing device;

FIG. 6 is a flow diagram illustrating an exemplary cut/copy routine for implementation by an intelligent clipboard; and

FIG. 7 is a flow diagram illustrating an exemplary paste routine for implementation by an intelligent clipboard

FIG. 8 is a block diagram illustrating an exemplary computing device suitably configured with an intelligent canvas and an enhanced clipboard.

### DETAILED DESCRIPTION

For purposes of clarity, the term “exemplary” in this document should be interpreted as serving as an illustration or example of something, and it should not be interpreted as an ideal and/or a leading illustration of that thing.

The term “content” refers to items and/or data that can be presented, stored, arranged, and acted upon. Often, but not exclusively, content corresponds to data/items that can be presented to a computer user via a computing device. Examples of content include, by way of illustration and not limitation, data files, images, audio, video, Web pages, user posts, data streams, and the like, as well as portions thereof. The term “user-relevant content” refers to content that is determined to be relevant to a computer user. This determination may be made according to the nature and/or amount of user interaction with content. Content may be deemed user-relevant content when particular thresholds regarding the nature and/or amount of user interaction with the content are met. For example (by way of illustration), a user-generated post to a social network may be considered “user-relevant” due to the fact that it was generated and posted by the user. Similarly, the entire social network thread in which the post was made may be viewed as “user-relevant” based on the fact that the user posted content to the thread.

The term “capture,” when used in the context of “capturing content,” refers to creating a record with regard to the referenced content (i.e., content to capture). The record (referred to as a content card) may include a duplicate copy of the referenced content or, alternatively, may include a reference to the content, and/or may also include relevant elements of information of the referenced content as well as references to the content. Further still, the record may include additional information about the content beyond just the content: metadata regarding the content, the context of user access to the content, a URL (universal resource locator) that identifies the location of the content on a network, and the like. As will be discussed below, as part of capturing content, rich, robust information of the content is also captured. This rich information includes information such as a semantic understanding of the data, semantic relationships and data structures, and the like.

As suggested above, the disclosed subject matter is directed to facilitating the capture of user-relevant content and to efficiently and readily accessing content located outside of the present execution context. More particularly, according to a first set of aspects of the disclosed subject matter, a process that captures user-relevant content is disclosed. This process is typically an on-going process, i.e., it continually operates, including operating in the execution background, of a computing device. This content capture process captures user-relevant content according to explicit user direction and/or captures content in an automated manner (e.g., when the thresholds for determining that content is relevant to the user are met). Of course, a computer user may also explicitly indicate that particular content should be captured (and, therefore, is user-relevant). The content that is captured by the process is viewed as rich or robust content in that the captured information includes a semantic understanding of the relationships with the content, data structures and organizations/arrangements of the content, contextual information regarding both the user's access of the content as well as the presentation of the content, metadata relating to the content, and the like. The captured information is organized and arranged into content cards and stored in a content card store corresponding to and associated with the user. As will be discussed below, the content card store may be stored locally on the associated user's computing device, in a shared or online location such that the content card store may be made readily accessed over a network, or as a combination of both local and networked storage. As will be appreciated by those skilled in the art, network storage may include “in the cloud storage,” i.e., a network-accessible storage device maintained by a third party or service for the benefit of its subscribers.

In addition to the on-going process of capturing user-relevant content and according to additional aspects of the disclosed subject matter, an intelligent canvas is implemented to facilitate access to content that lies outside of the current execution content on the computing device. The intelligent canvas is implemented as an operating system level service (i.e., the intelligent canvas is accessed in a manner consistent with accessing operating system services, irrespective of whether or not the intelligent canvas is a part of the operating system or not) such that a computer user can readily interact with the canvas to access content that is only accessible from outside of the current application context (i.e., would require the user to switch execution content—such as switching to another application on the computer device—or rely on an operating system service to access the content) on a computing device. In other words, as the intelligent canvas is provided as an operating system level service, a user may remain in the current application/execution content and explore and access rich content that would otherwise require one or more context switches to access.

According to yet additional aspects of the disclosed subject matter, an intelligent clipboard is presented. A computer user is advantageously able temporarily capture the rich/robust content of a content that a computer user is currently accessing and capture the rich/robust content onto the clipboard (i.e., temporarily store the rich/robust content in a data store associated with the intelligent clipboard.) Further still, rather than maintain the content in an “as is” format which is typical of most clipboard features, one or more content cards are generated from the captured content. These one or more content cards may be used to paste information into an application in the same manner as the content from content cards are applied to applications from the intelligent canvas (as described in greater detail below).

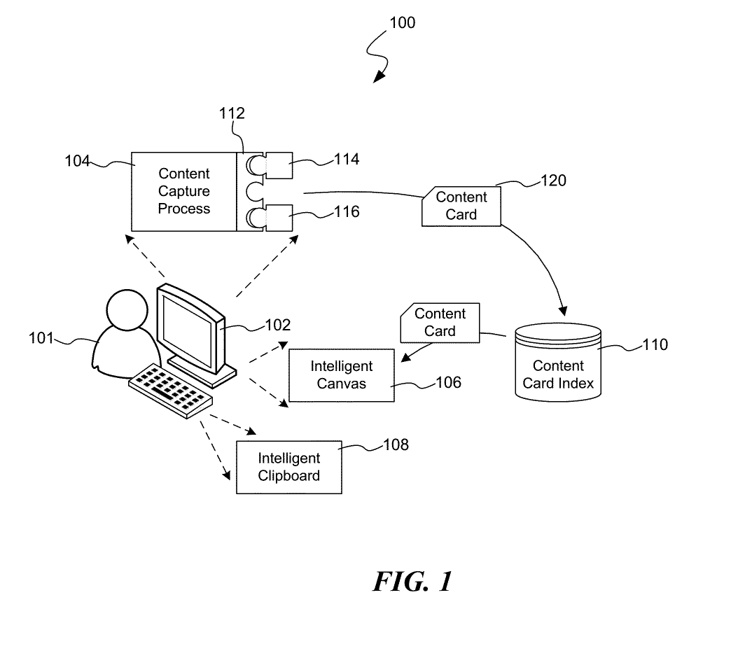

Turning now to the Figures, FIG. 1 is block diagram illustrating an interaction 100 between exemplary components of a computing device 102 suitably configured to implement various aspects of the disclosed subject matter. In particular, the interaction 100 illustrates and occurs among particular logical components on a computing device 102, including the on-going content capture process 104, the intelligent canvas 106, the intelligent clipboard 108, and the content card index 110.

As should be readily appreciated, in the course of using a computer, such as user computer 102, a computer user 101 (or more alternatively, the user 101) is typically exposed to substantial amount of content. Of course, some of the content may be generated by the user, though generally speaking a large majority of the content that is accessed by a user is generated by others. Moreover, some of the content that a computer user, such as computer user 101, may view is likely of enough importance or relevancy to the user that the user may wish to capture that content. According to aspects of the disclosed subject matter and as suggested above, the content capture process 104 analyzes the various content items that a user may access, view, and/or generate and make determinations as to whether or not the content is user-relevant content such that the content should be captured and stored for and on behalf of the user. These determinations may be made according to the nature, type, quality and quantity of interactions a user may have with the content, as well as according to explicit user instruction.

Regarding the content capture process 104, as mentioned this process is typically, but not exclusively, configured as an ongoing, executing process on the user computer 102. Of course, in various configurations (not shown) the content capture process 104 may work in conjunction with content capture processes executing on other devices for the benefit of the computer user 101. For example, in addition to a content capture process 104 executing on a user's computer device, such as computing device 102, a related, sibling content capture process (not shown) may be operating on server computer on behalf of the user (or a plurality of users) to identify and capture user-relevant content.

Because there are numerous types and arrangements of content that may be determined to be user-relevant, rather than coding the content capture process 104 with a finite, limited set of content types that may be captured, the content capture process 104 instead includes a framework 112 that enables the content capture process to be updated with capture modules, such as capture modules 114 and 116, where each capture module may be configured to capture content of a particular type. The content capture process 104 may be configured to obtain, as needed or as updates, capture modules from a source, such as Web page of the provider of the content capture module (not shown.) Further still, depending on the capabilities of the computing device 104, a limited set of capture modules may be installed into the framework 112 and another set of capture modules, potentially much larger, may be implemented on network accessible computing device operating a related or sibling content capture process.

According to aspects of the disclosed subject matter, the source of the content accessed by the user may include, by way of illustration and not limitation, user files, Web pages, emails, user posts, blogs, data streams, and the like. When content is determined to be user-relevant, the content capture process (including/using the capture modules) captures the content such that it is recorded in one or more content card, such as content card 120. Each content card corresponds to a particular item of content and may contain rich, robust information regarding the content including semantic information regarding the content, relationships, arrangements and structures, contextual data, and the like. Additionally, according to various non-exclusive embodiments of the disclosed subject matter, the content capture process 104, rather than generating a content card, such as content card 120, for a particular item of accessed content, the content capture process may update an already existing content card with updated, new, or more recent information.

In order to easily retrieve the subject matter of each content card, such as content card 120, various elements of the content cards may be used as index keys into an index of the content cards stored in the content card index 110. Indexing information, such as content cards, according to one or more index keys is known in the art. As mentioned above, the content card index 110 may be stored locally on a user's computing device, such as computing device 102, or in a shared location for access by the user from multiple devices, such as a network drive or in cloud storage.

While not shown, as will readily appreciated by those skilled in the art, many computer users typically interact with and/or use more than one computing device. For example, a typical computer user may make use of a desktop computer stationed at his/her home, a laptop and/or tablet computer when traveling, as well as a smartphone or so-called “phablet” (a device residing between a smart phone and a tablet computer.) Of course, a computer user may wish to have access to all of the same content irrespective of the computing device currently employed. Accordingly, in aspects of the disclosed subject matter each of the computing devices related to a user will be configured to be able to access the content card index 110 through the intelligent canvas 106.

As also shown in FIG. 1, an intelligent canvas 106 operating on the computing device 102 may access one or more content cards from the content card index 110, as will be set forth in greater detail below. Of course, by the use of an application or other service designed to review content cards in a content card index 110, a computer user may be able to copy a content card onto the intelligent clipboard 108. More particularly, the computer user can peruse the content cards of the content card index 110 and, while viewing a content card, copy the content card onto the intelligent clipboard 108 for copy and/or paste operations, thereby making use of the rich information of the content cards in the content card index 110.

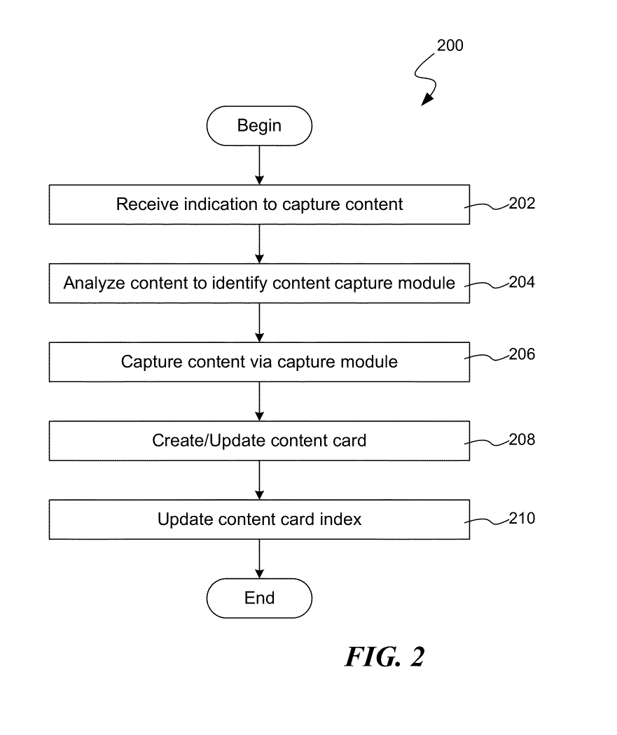

Turning to FIG. 2, FIG. 2 is a flow diagram illustrating an exemplary routine 200 for capturing user-relevant content via a content capture process 112, and generating content cards and storing and indexing them in a content card index 110 corresponding to a computer user. Beginning at block 202, the content capture process 104 receives an indication or instruction to capture user-related content. This indication or instruction may be generated according to explicit user instruction to capture a particular item or set of content, such as when the computer user may indicate that a particular web page should be captured, or alternatively, according to an on-going analysis (which may be part of the content capture process 104) of the nature, amount and/or frequency, and quality of user access of the content, such as when the computer user generates a post or frequently reviews a particular online image.

At block 204, the user-related content to be captured is analyzed to determine the nature of the content in order to identify a suitable content capture module, such as content capture module 114 or 116 of FIG. 1. According to aspects of the disclosed subject matter, analysis of the content may be made, by way of illustration and not limitation, in regard to the content format, the source of the content, metadata related to the content, and the like. For example, if the content is an XML (extensible markup language) page, a content capture module for capturing XML documents may be selected to capture the content. Alternatively, if the content is an email containing an online bill from a mobile phone vendor, then a content capture module corresponding to the particular online bill/mobile phone vendor may be selected. Correspondingly, at block 206 the content is captured by the selected content capture module. Generally speaking, each of the content capture modules is configured to capture relevant aspects of the content. For example, the content capture module for the online bill/mobile phone vendor may be configured to capture the amount of the bill, the date of billing, the due date of the bill, previous balances, the mobile phone vendor name, and the like. Of course, depending on the nature of the content, contextual information may be captured (such as information identifying the social thread of the user's post), semantic information, relationships among the data, structural organizations, and the like.

At block 208, a content card is generated from the captured content. Of course, in capturing the content, a content capture module may alternatively determine that the content is already captured and, instead of creating a content card, update and/or modify an existing content card. For example, in regard to the online phone bill from the mobile phone vendor, the content capture module may determine that there is already a content card corresponding to a bill from the mobile phone vendor. Thus, in this example, rather than generating a new content card, the content capture module may instead update the information in the existing content card such that it reflects the latest information per the online phone bill.

At block 210, the content card index 110 is updated with the content card. Thereafter, the routine 200 terminates.

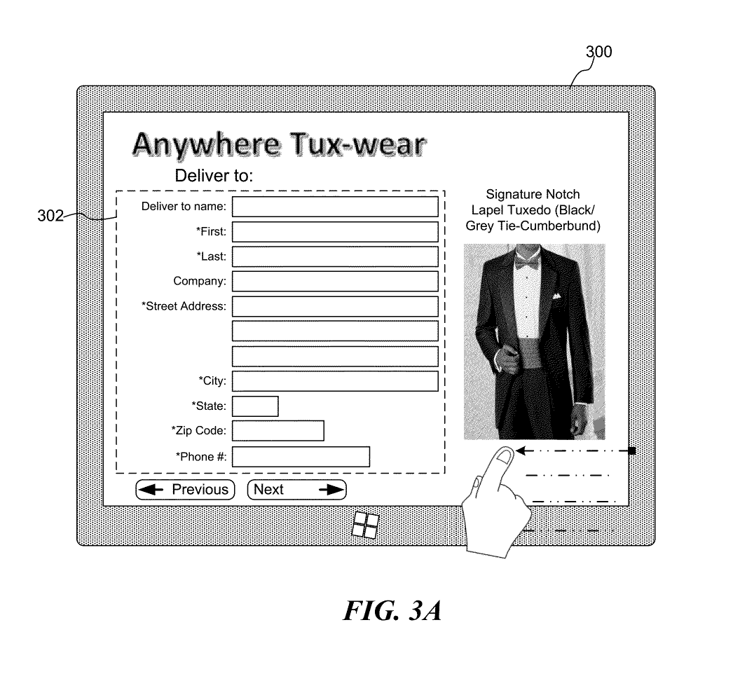

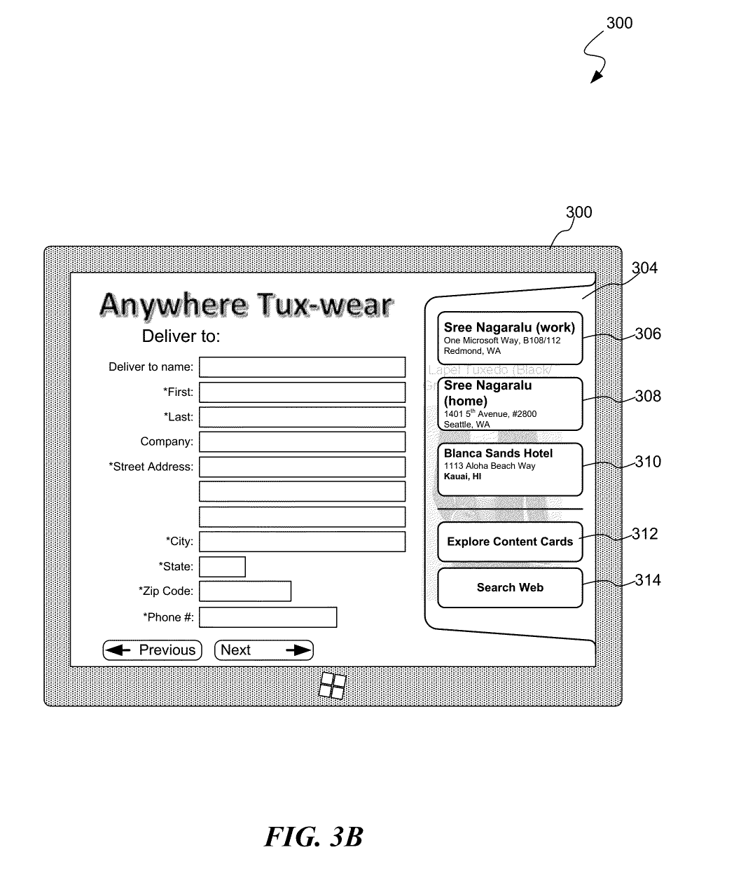

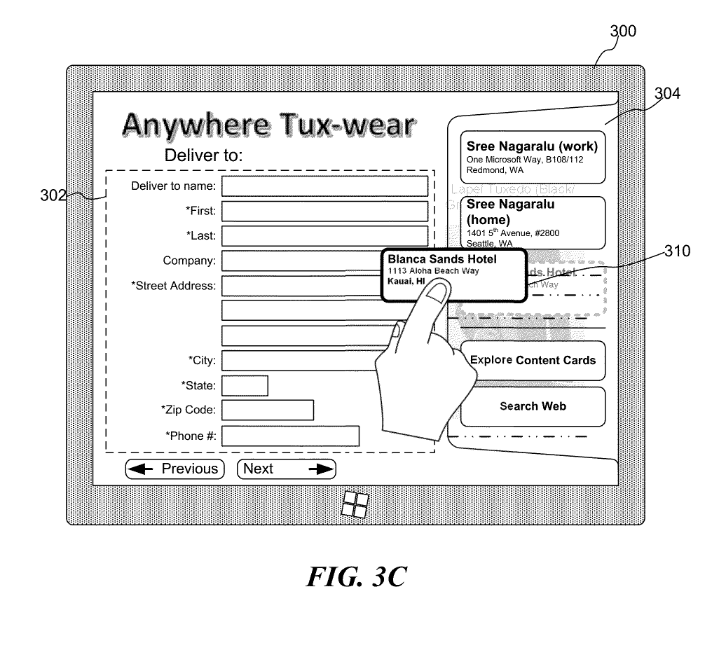

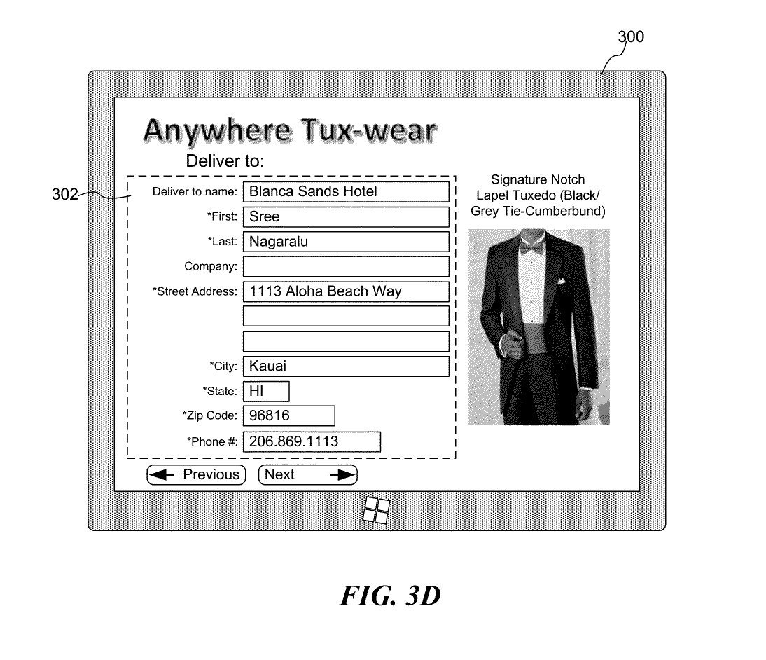

According to additional aspects of the disclosed subject matter and as indicated above, an intelligent canvas 106 may be implemented on the user computer 102. Moreover, while the intelligent canvas 106 may be advantageously used in combination with the content card index 110, as will be seen the intelligent canvas is not so limited and may operate with information outside of the content card index. As mentioned above, the intelligent canvas 106 is an operating system level service (irrespective of whether or not the service is implemented by the operating system or from a third-party vendor) that enables the user to access content outside of the current execution context of an application, thus freeing the computer user of the need to change execution context. More particularly, the intelligent canvas is frequently implemented as a modal service that can be invoked while within a particular execution context (such as during the execution of an application), enable the user to view and select content from one or more sources, such as the content card index 110, and import the selected content into the execution context. To better illustrate how the intelligent canvas operates, reference is first made to FIGS. 3A-3D.

FIGS. 3A-3D are pictorial diagrams illustrating user interaction with an illustrative embodiment of an intelligent canvas 106 implemented on a computing device, such as computing device 102. For purposes of illustrating the operation and advantages of the intelligent canvas, the discussion of these figures will be made with regard to the scenario where the computer user 101 is traveling to a vacation location and will be staying at a hotel at that location. Moreover, the computer user 101 will be in need of a tuxedo while there and has decided that he will rent a tuxedo at the location. FIG. 3A illustrates an exemplary display view 300 as may be displayed on the user's a computing device 102 in securing a tuxedo rental at his vacation location. Naturally, the computer user will wish to have the rented tuxedo delivered to the hotel at which he is staying. Thus, the display view 300, in its current execution context, is displaying a shipping form 302 related to the location of delivery for the rental tuxedo 302. Unfortunately, as is typically the case, the computer user 101 does not know from memory the specific address of the hotel. Of course, the computer user 101 could switch away from the current execution context (the display of the rental form 302) to his email confirmation of the hotel to obtain the delivery address. However, by interacting with an intelligent canvas 106 implemented on the computing device 102 the use can remain in the current execution context.

According to aspects of the disclosed subject matter, the interactive canvas is presented to the computer user 101 without leaving the current execution context through the activation of a triggering action. A triggering action may correspond to any number of user actions including, by way of illustration and not limitation, one or more key-presses or key-press sequence, an audio command, a gesture on a touch sensitive surface, an optically sensed gesture, and the like. In FIG. 3A, the user action is a swipe on a touch-sensitive surface (the screen), but this is illustrative and should not be viewed as limiting. More particularly, with reference to FIGS. 3A and 3B, as the computer user swipes his finger from a location designated for activating an intelligent canvas 106, an intelligent canvas view 304 is presented on the display view.

According to aspects of the disclosed subject matter, the intelligent canvas 106 provides a user-interface (the intelligent canvas view 304) through which a computer user can identify/select content that may be imported into the current execution context. Further still, while not shown the intelligent canvas may include the functionality by which a user can further place the selected content (as a content card) onto the intelligent clipboard 108. As can be seen, the illustrated intelligent canvas view 304 includes various selectable controls 306-314 by which the computer user can view, explore, and/or select content for use in the current execution context.

According to aspects of the disclosed subject matter, an intelligent canvas 106, upon activation, may be configured to determine the nature of the current execution context and proactively provide likely content that would be relevant to the user in that context. For example, the intelligent canvas view 304 presents selectable controls 306-310 relating to addresses, illustratively obtained from the user's corresponding content card index. As shown in FIGS. 3C and 3D, By activating control 310 (in this illustrative example by dragging the control onto the rental form 302 in the display view 300, the computer user may notify the application of the current execution content which, in turn, will import the relevant data of the content card represented by the control 310 into the form.

Applications typically should support the ability to accept information from a content card. Typically, but not exclusively, the intelligent canvas 106 is configured to query an application/execution context to determine the “types” of information that the application/execution context can accept. As those skilled in the art will appreciate, the “types” of information correspond to, by way of illustration and not limitation, the particular formats of data or information that an application may accept, data structures, semantic information, and the like. For example, the content card selected in the example of FIGS. 3A-3C may include structural data regarding a hotel to where a user will be traveling. In the example, the application is able to accept structured data (fields with corresponding values/data) and insert the information into the rental form 302.

Returning to FIG. 3B, in addition to selecting one of a plurality of “suggested” content cards, such as content cards 306-310, that are proactively identified as potential selections for the use given the current context of the application/execution context, an intelligent canvas 106 operating on the computing device can also be configured to provide the computer user with the ability to browse through all of the content cards that are available to the user in the user's content card index. Moreover, while not shown, the computer user is also provided with the ability to select a content card for importation into the application/current execution content. For example and as shown in FIG. 3B, user-actionable control 312 provides a user interface control by which the use can invoke the browsing ability of the content cards in the content index.

In addition to browsing/viewing the content cards of the user's corresponding content card index, the intelligent canvas 106 may provide additional channels on an intelligent canvas view 304 by which a user can obtain data residing outside of the current execution context and outside of the user's content card index. By way of example and as shown in FIG. 3B, the intelligent canvas view 304 includes a user-actionable control 314 by which the user is provided with the ability to search the Web/Internet for content to be imported into the current execution context. Through all of these features, the computer user is advantageously provided with tools that enable the user access information that is external to the current execution context without switching away from the current execution context. Moreover, by way of the content capture process, the user is able to readily capture content (including semantic information regarding the captured content) in a centralized location, and have the captured content readily accessible for subsequent access through the intelligent canvas. These advantages are significant improvements over the present methods of obtaining content (by saving files, receiving emails, etc.) and subsequently needing to remember where desired data is located, and switching execution contexts in an effort to import such information into the current execution context.

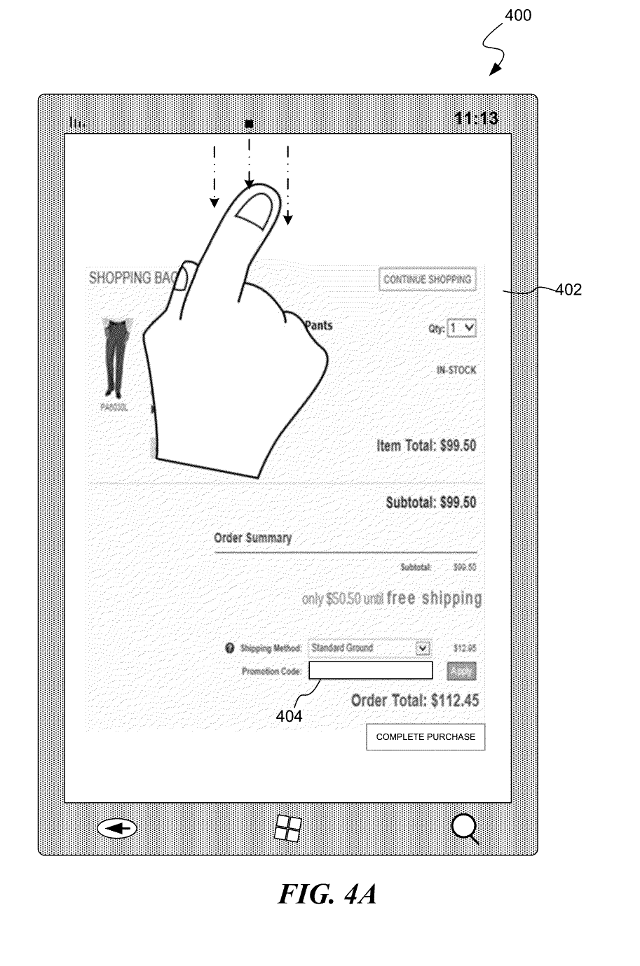

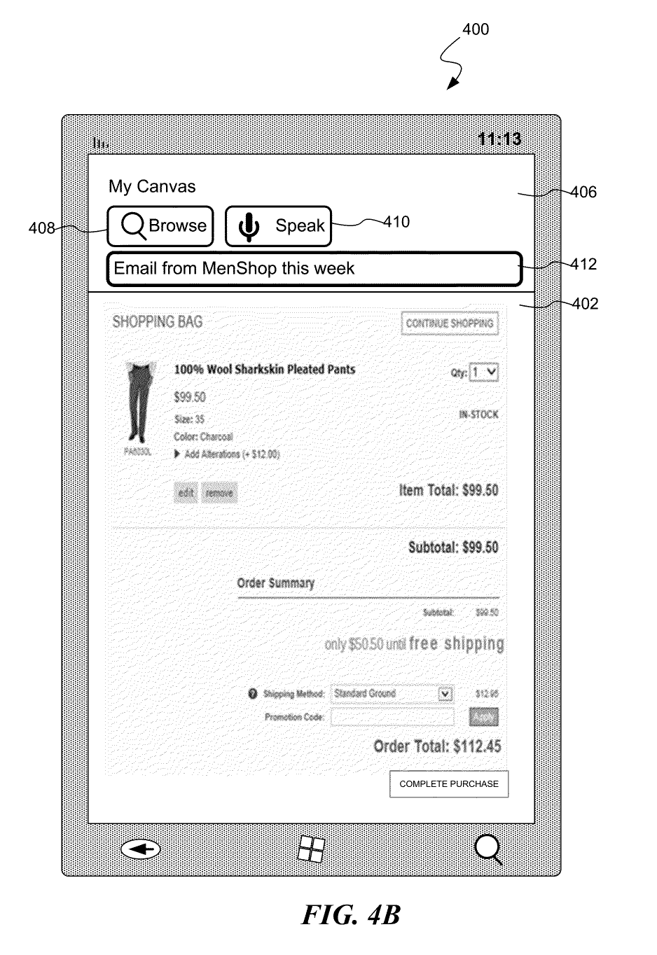

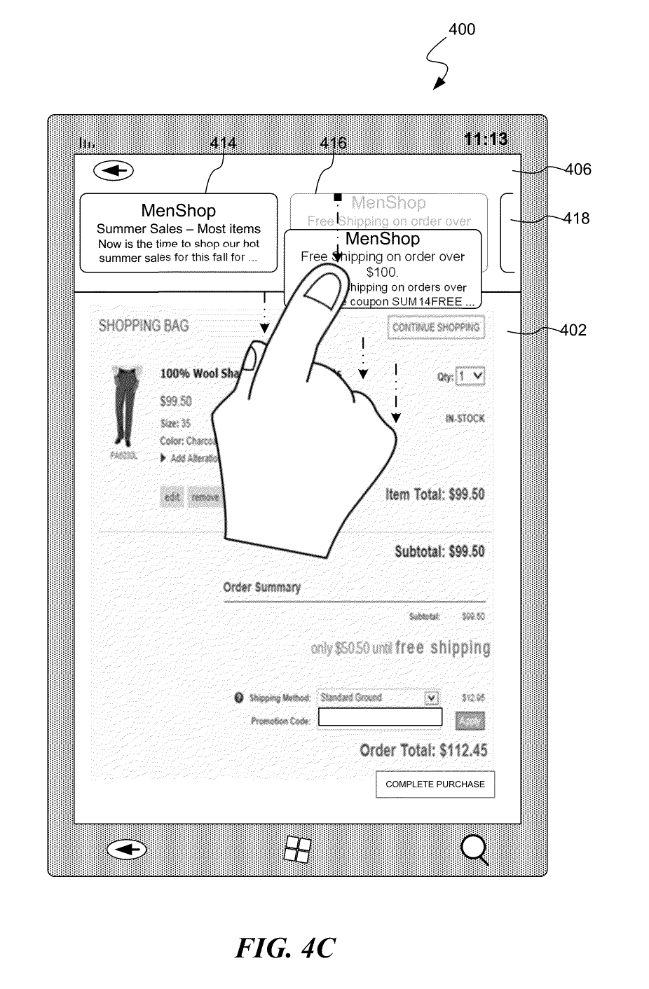

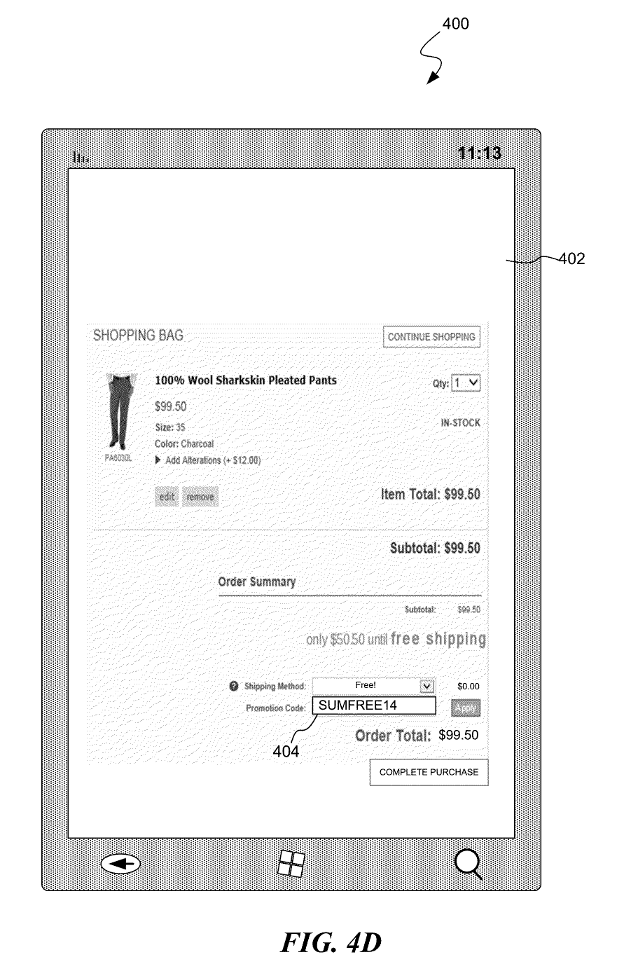

Turning now to FIGS. 4A-4D, these figures are pictorial diagrams illustrating an alternative user interaction with an illustrative embodiment of an intelligent canvas 106 implemented on an alternative computing device 400. More particularly, FIGS. 4A-4D illustrate a user interaction with an intelligent canvas as illustratively implemented on a mobile computing device 400, such as a smart phone. By way of example with regard to FIGS. 4A-4D, the computer user is in the process of purchasing trousers from an online Web service and recalls that the user has received an email regarding a promotion from the vendor for free shipping. Of course, the user will want to take advantage of this promotion from the vendor. In this scenario and on a computer system without an intelligent canvas, the user would need to switch from the present execution context (that of purchasing the trousers) to an email application, find the email that includes the promotional code, copy the promotional code (or memorize it), and transfer back to the execution context in which the user can enter the promotional code into the corresponding promotion code field 404. Alternatively and advantageously, when an intelligent canvas is operating on the computing device 400, the user can initiate interaction with the intelligent canvas to access the information without leaving the current/present execution context. Indeed, as shown by way of example in FIG. 4A, the computer user may swipe down (a gesture known in the art with regard to touch sensitive devices) from the top of the display screen 402 to interact with an intelligent canvas service operating on the computing device.

Continuing the example with regard to FIG. 4A above, upon the user activating the intelligent canvas service 106, an intelligent canvas view 406 is displayed to the user. In this illustrative embodiment, the intelligent canvas view 406 includes an anticipatorily identified contact card (represented by control 412) as well as a control 408 for browsing (either the content card index or other sources such as the web) and a control 410 for receiving audio commands in the intelligent canvas. In this example, due to the nature of the current execution context, the intelligent canvas as anticipatorily identified a content card (represented by control 412) relating to an email from the vendor at which the user is currently attempting to purchase the trousers.

Turning to FIG. 4C, assuming that the user has selected the browsing control 408, a series of content cards 414-418 are displayed to the user from which the user has selected content card 416 (by pulling the card down out of the intelligent canvas view 406 into the display screen 402. Of course, this is one illustrative embodiment of selecting a content card and should not be viewed as the only manner in which a user can select a content card.

Based on the information in the selected content card and according to the information that the application of the current execution context can accept, the information of the content card is imported into the application. As shown in FIG. 4D, the promotional code included in the email from the vendor (as represented in the content card 416) is imported into the appropriate field. As suggested above, the information in the content card may include both field labels and values such that the application can make appropriate use of the imported content—in this example retrieving the promotional code from the content card 416 and placing the promotional code in the promotional code field 404.

While the illustrated embodiments of an intelligent canvas 106 as shown in FIGS. 3A-3D and 4A-4A are made with regard to a touch-sensitive device, it should be appreciated that these are illustrative embodiments of the user interface of the intelligent canvas and should not be viewed as the only examples. An intelligent canvas may be configured to interact with any number of user interfaces such as, by way of illustration: key-press sequences; voice commands; pointing devices (such as a mouse, track-pad, and the like); physical gestures (which are sensed by optics or radio triangulation); movements of the device (as may be sensed by accelerometers and other motion sensing devices); and the like.

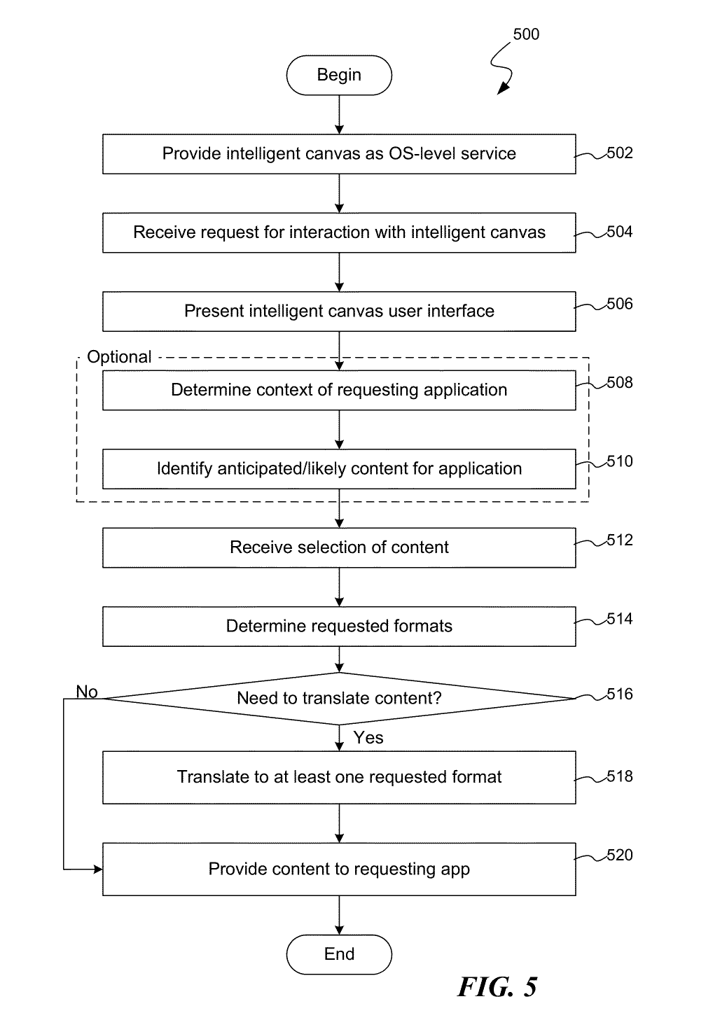

Turning now to FIG. 5, FIG. 5 is a flow diagram illustrating an exemplary routine 500 for implementing an intelligent canvas 106 on a computing device. Beginning at block 502, an intelligent canvas is provided on a computing device. According to aspects of the disclosed subject matter, the intelligent canvas is provided as an operating system-level service. In regard to the intelligent canvas, while it may be provided an operating system-level service, it should be appreciated this means that the operates as an extension of the current execution context (i.e., invoking the intelligent canvas does not cause a change in the current execution context but is viewed as an extension of the execution context) irrespective of whether or not it is implemented at the operating system level, as a cloud service, a shell service, a browser plug-in, or the like. Moreover, irrespective of the particular manner in which it is implemented, the invocation and interaction with the intelligent canvas is the same on the computing device. At block 504, a request for interaction with the intelligent canvas is received. At block 506, the user interface of the intelligent canvas is presented to the requesting user.

At block 508, contextual information of the current execution context/application is optionally determined. As indicated above, the intelligent canvas 106 can make use of the contextual information in anticipatorily identifying content that the computer user may wish to access. Thus, at block 510, the intelligent canvass optionally identifies (and presents) the anticipated/likely content for the user given the current application/execution context.

At block 512, the intelligent canvas 106 receives a selection of content. As indicated above, the selection of content may be the selection of a content card from the user's content card index, or may be from another source, such as the internet, the user's email, a file on the computing device, and the like. At block 514, a determination is made as to the various formats or types that the current execution context can accept. At decision block 516, a determination as to whether the intelligent canvas needs to translate the selected content is made. For example, a determination may be made as to whether the intelligent canvas must translate the content of a selected content card into format that the execution context can accept. If yes, the routine 500 proceeds to block 518 where the intelligent canvas translates the selected content (or obtains a translation of the selected content) in a requested format. It should be appreciated that while the translation of the selected content may be implemented by the application/current execution context, or by the intelligent canvas, in yet a further embodiment the intelligent canvas may rely upon an online service to provide a translation for the selected content. Alternatively, or after translating the selected content, at block 520 the content is provided to the current execution context/application. Thereafter, routine 500 terminates.

While the above discussion is made in regard to accessing content cards in a content card index by way of an intelligent canvas 106 which provides an operating system level service so that a user is not forced to switch from the current execution context to access data external to the execution context, the content cards of the content card index 110 may be made accessible to an intelligent clipboard 108, i.e., an interface provided to view content cards in the content card index 110 and perform a copy operation to temporarily place a content card into the temporary storage of the intelligent clipboard 108. Of course, the intelligent clipboard 108 is typically implemented to capture content that is currently viewed (or selectively identified) by the user onto the intelligent clipboard's temporary storage by use of a cut or copy operation with regard to the currently selected (or viewed) content.

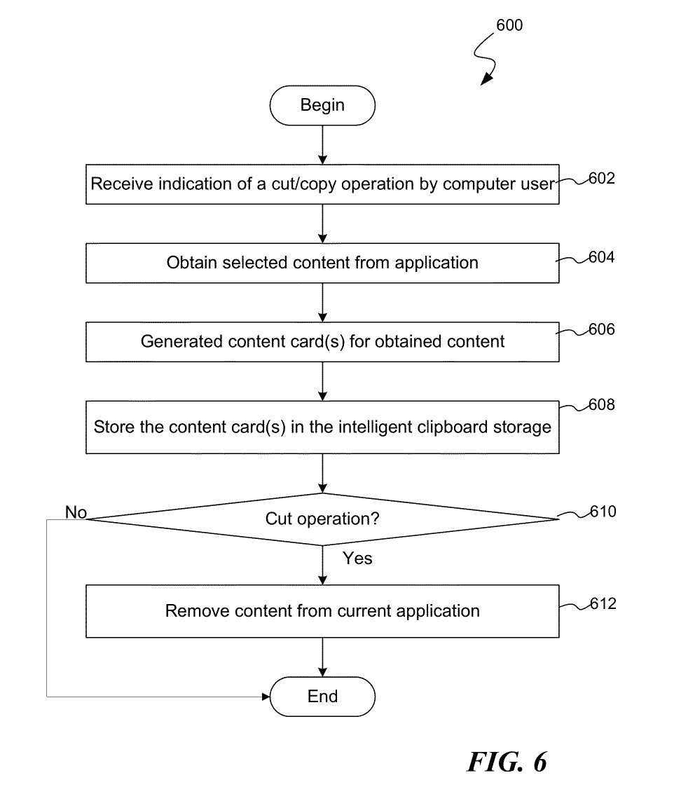

FIG. 6 is a flow diagram illustrating an exemplary routine 600 for implementing a copy (or cut) operation to an intelligent clipboard 108. Beginning at block 602, the intelligent clipboard receives an indication from the computer user of a cut operation (e.g., place selected content from the current execution context/application, place onto the intelligent clipboard, and remove the selected content from the current execution context) or a copy operation (e.g., place the selected content from the current execution context onto the intelligent clipboard). At block 604, the intelligent clipboard obtains the selected content from the current execution context/application. As indicated above, when obtaining the selected or current content, rich and robust information is obtained, including semantic information, structural relationships, context data, and the like At block 606, the intelligent clipboard 108 dynamically generates one or more content cards for the obtained content. At block 608, the content card (or content cards) are stored in the intelligent clipboard's temporary storage. At decision block 610, a determination is made as to whether this is a copy or cut operation. If the operation is a “cut” operation, at block 612 the selected content is removed from the current application. Thereafter, or if this is a copy operation, the routine 600 terminates.

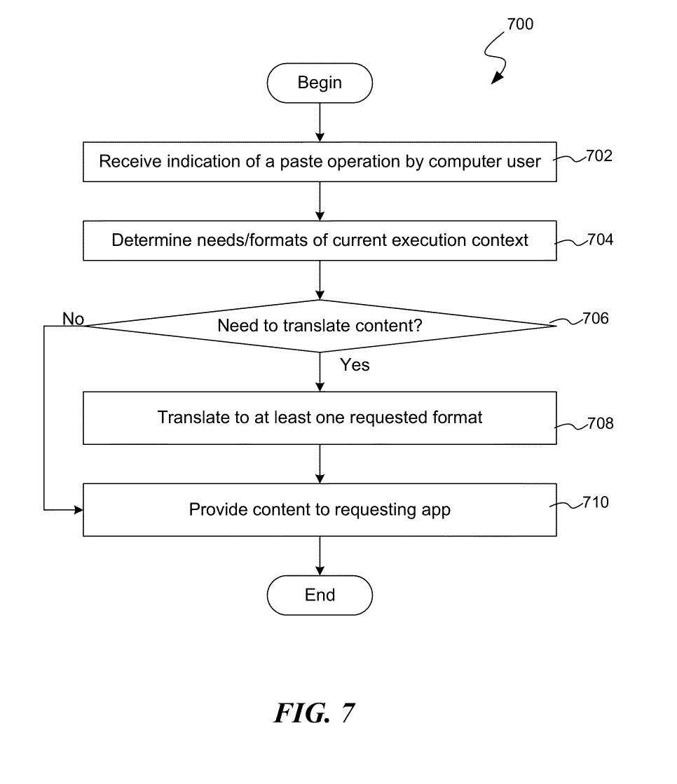

FIG. 7 is a flow diagram illustrating an exemplary routine 700 for implementing a “paste” operation with regard to the intelligent clipboard. Beginning with block 702, the intelligent clipboard 108 receives an indication/instruction from the computer user to perform a paste operation (i.e., copy the current clipboard content to the current execution context/application.) At block 704, the intelligent clipboard 108 determines the current needs of the current execution context—i.e., the needs and/or formats that are acceptable to the current execution context. At decision block 706, a determination is made as to whether the content (as a content card) held by the intelligent clipboard must be translated. If yes, at block 708 the content is translated. Alternatively or thereafter, at block 710, the content is provided to the current execution context. Thereafter, the routine 700 terminates.

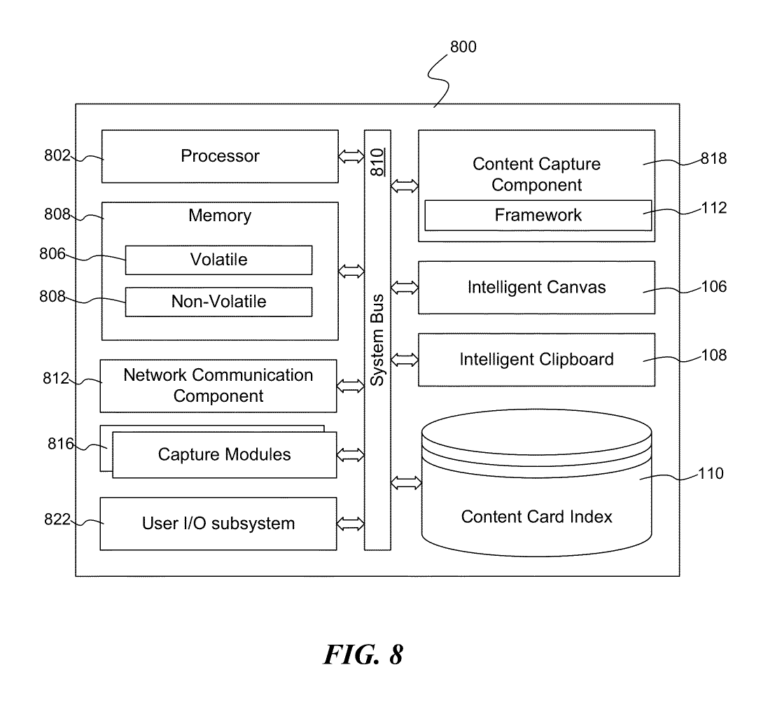

Regarding the routines described above (in regard to FIGS. 2, 5-7), as well as other processes describe herein, while these routines/processes are expressed in regard to discrete steps, these steps should be viewed as being logical in nature and may or may not correspond to any actual and/or discrete steps of a particular implementation. The order in which these steps are presented in the various routines and processes should not be construed as the only order in which the steps may be carried out. Moreover, while these routines include various novel features of the disclosed subject matter, other steps (not listed) may also be carried out in the execution of the routines. Those skilled in the art will appreciate that logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on computing devices, such as the computing device described below in regard to FIG. 8. In various embodiments, all or some of the various routines may also be embodied in executable hardware modules, including but not limited to system on chips, specially designed processors and or logic circuits, and the like on a computer system.

These routines/processes are typically implemented in executable code comprising routines, functions, looping structures, selectors such as if-then and if-then-else statements, assignments, arithmetic computations, and the like. However, the exact implementation in executable statement of each of the routines is based on various implementation configurations and decisions, including programming languages, compilers, target processors, operating environments, and the like. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied in applications (also referred to as computer programs), apps (small, generally single or narrow purposed applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions that are stored on the computer-readable storage devices are executed, they carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

Turning now to FIG. 8, FIG. 8 is a block diagram illustrating an exemplary computing device 800 suitably configured with an intelligent canvas 106 and an intelligent clipboard 108. The exemplary computing device 800 includes a processor 802 (or processing unit) and a memory 804, interconnected by way of a system bus 810. As will be readily appreciated, the memory 804 typically (but not always) comprises both volatile memory 806 and non-volatile memory 808. Volatile memory 806 retains or stores information so long as the memory is supplied with power. In contrast, non-volatile memory 808 is capable of storing (or persisting) information even when a power supply is not available. Generally speaking, RAM and CPU cache memory are examples of volatile memory 806 whereas ROM, solid-state memory devices, memory storage devices, and/or memory cards are examples of non-volatile memory 808.

The processor 802 executes instructions retrieved from the memory 804 in carrying out various functions, particularly in regard to capturing content into a content card index, providing an intelligent canvas, and providing an intelligent clipboard as described above. The processor 802 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: personal digital assistants, wearable computing devices, smart phone devices, tablet computing devices, phablet computing devices, laptop computers, desktop computers, and the like.

The system bus 810 provides an interface for the various components of the mobile device to inter-communicate. The system bus 810 can be of any of several types of bus structures that can interconnect the various components (including both internal and external components). The exemplary computing system 800 further includes a network communication component 812 for interconnecting the computing device 800 with other network accessible computers, online services, and/or network entities as well as other devices on the computer network. The network communication component 812 may be configured to communicate with the various computers and devices over a network (not shown) via a wired connection, a wireless connection, or both.

Also included in the exemplary computing device 800 is a content capture component 818, which implements the content capture process 104 described above. As indicated above, the content capture process may be configured to utilize a framework 112 such that it can be updated with various content capture modules, such as capture modules 816. Typically, but not exclusively, the capture modules 816 are software components that interface with the framework 112 of the content capture component 818. The captured content is embodied in content cards that are stored in a content card index 110.

Also included in the exemplary computing device 800 is an intelligent canvas module 106. As set forth above, the intelligent canvas module is implemented as an operating system-level service which can be accessed by a user of the computing device 800 without changing the current execution context on the computing device. The intelligent canvas module 106 interfaces with a computer user to provide the functionality described above by way of the user I/O subsystem 822 of the computing device 800. Still further, the exemplary computing device 800 includes an intelligent clipboard 108 as described above.

Regarding the various components of the exemplary computing device 800, those skilled in the art will appreciate that these components may be implemented as executable software modules stored in the memory of the computing device, as hardware modules (including SoCs—system on a chip), or a combination of the two. Moreover, each of the various components may be implemented as an independent, cooperative process or device, operating in conjunction with or on one or more computer systems and or computing devices. It should be further appreciated, of course, that the various components described above in regard to the exemplary computing device 800 should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broken up across multiple actual components and/or implemented as cooperative processes on a computer network.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for providing improved access to content accessible outside of the current execution context, the method comprising each of the following as implemented on a computing device:
providing an intelligent canvas as a service on the computing device, the intelligent canvas being provided as an operating system-level service, wherein interaction with the intelligent canvas does not require a change from the current execution context;
receiving a request to interact with the intelligent canvas; and
presenting an intelligent canvas view for display on the computing device, wherein the intelligent canvas view includes a plurality of user-actionable controls and wherein at least one user-actionable control corresponds to content for importing into the current execution context, and wherein corresponding content of the at least one user-actionable control is anticipatorily selected for presentation in the intelligent canvas view.

2. The computer-implemented method of claim 1 further comprising receiving a selection of the at least one user-actionable control and providing the corresponding content to the current execution context.

3. The computer-implemented method of claim 2 further comprising:
determining a set of content formats for importing content to the current execution context;
determining whether the corresponding content is available in one of the set of formats; and
providing the corresponding content to the current execution context in at least one of the set of content formats.

4. The computer-implemented method of claim 3 further comprising:
determining that the corresponding content is not currently available in one of the set of formats;
causing a translation of the correspond content to at least one of the set of content formats; and
providing the translated corresponding content to the current execution context in at least one of the set of content formats.

5. The computer-implemented method of claim 2 further comprising:
executing a content capture process on the computing device, wherein the content capture process executes in the background of the computing device and wherein the content capture process is configured to:
capture content accessed by the user; and
store the captured content as one or more content cards in a content card index associated with the user; and
wherein the corresponding content of the at least one user-actionable control is selected from the captured content in the content card index.

6. The computer-implemented method of claim 5, wherein a first user-actionable control of the plurality of user-actionable controls is a control for browsing the captured content stored in the content card index.

7. The computer-implemented method of claim 6, wherein a second user-actionable control of the plurality of user-actionable controls is a control for browsing a network for content.

8. The computer-implemented method of claim 1, wherein the intelligent canvas operates as a modal service to the current execution context.

9. The computer-implemented method of claim 1, wherein the corresponding content of the at least one user-actionable control is anticipatorily selected for presentation in the intelligent canvas view according to the current execution context.

10. A computer-readable medium bearing computer-executable instructions which, when executed on a computing device comprising at least a processor and a memory, cause a computing device to carry out a method for providing improved access to content accessible outside of the current execution context, the method comprising:
providing an intelligent canvas as a service on the computing device, the intelligent canvas being provided as an operating system-level service, wherein interaction with the intelligent canvas does not require a change from the current execution context;
providing a content capture process on the computing device, wherein the content capture process executes in the background of the computing device and wherein the content capture process is configured to capture content accessed by the user and store the captured content as one or more content cards in a content card index associated with the user; and
receiving a request to interact with the intelligent canvas; and
presenting an intelligent canvas view for display on the computing device, wherein the intelligent canvas view includes a plurality of user-actionable controls and wherein at least one user-actionable control corresponds to content for importing into the current execution context, and wherein corresponding content of the at least one user-actionable control is anticipatorily selected for presentation in the intelligent canvas view from the captured content in the content card index.

11. The computer-readable medium of claim 10, the method further comprising receiving a selection of the at least one user-actionable control and providing the corresponding content to the current execution context.

12. The computer-readable medium of claim 11, the method further comprising:
determining a set of content formats for importing content to the current execution context;
determining whether the corresponding content is available in one of the set of formats; and
providing the corresponding content to the current execution context in at least one of the set of content formats.

13. The computer-readable medium of claim 12, the method further comprising:
determining that the corresponding content is not currently available in one of the set of formats;
causing a translation of the correspond content to at least one of the set of content formats; and
providing the translated corresponding content to the current execution context in at least one of the set of content formats.

14. The computer-readable medium of claim 13, wherein a first user-actionable control of the plurality of user-actionable controls is a control for browsing the captured content stored in the content card index.

15. The computer-readable medium of claim 14, wherein a second user-actionable control of the plurality of user-actionable controls is a control for browsing a network for content.

16. The computer-readable medium of claim 15, wherein the intelligent canvas operates as a modal service to the current execution context.

17. The computer-readable medium of claim 10, wherein the corresponding content of the at least one user-actionable control is anticipatorily selected for presentation in the intelligent canvas view according to the current execution context.

18. A computing device for providing improved access to content accessible outside of the current execution context, the computing device comprising a processor and a memory, wherein the processor executes instructions stored in the memory as part of or in conjunction with additional components in providing improved access to content, the additional components comprising:
a content capture component configured to operate in the background on the computing device, and further configured to capture content accessed by a user of the computing device and store the captured content in a content card index; and
an intelligent clipboard configured to operate as an operating system-level service on the computing device, and further configured to, upon receiving a request from a user to interact with the intelligent clipboard, presents an intelligent canvas view for display on the computing device:
wherein the intelligent canvas view includes a plurality of user-actionable controls, and wherein at least one user-actionable control of the plurality of user-actionable controls corresponds to content for importing into the current execution context, and wherein corresponding content of the at least one user-actionable control is anticipatorily selected from a plurality of content cards in the content card index for presentation in the intelligent canvas view.

19. The computer device of claim 18, wherein the content capture component includes a framework for dynamically integrating one or more capture modules, each capture module configured to capture a particular format of content; and
wherein the computing device further comprises a plurality of capture modules.

20. The computer device of claim 18 further comprising an intelligent clipboard, wherein the intelligent clipboard is configured to access content cards in the content card index and, upon receiving a user action, further configured to paste the content of a content card stored in the content card index into the current execution context.
